(19) United States
(12) Patent Application Publication
(10) Pub. No.: US 2006/0147064 A1
(43) Pub. Date: Jul. 6, 2006

(54) Multi-effect processing device for wireless microphone

(75) Inventor: Ming-Lung Yang, Hong Kong (CN)

Correspondence Address: BACON & THOMAS, PLLC, 625 SLATERS LANE, FOURTH FLOOR, ALEXANDRIA, VA, 22314, US

(73) Assignee: SEIKAKU TECHNICAL GROUP LIMITED, HONG KONG (CN)

(21) Appl. No.: 11/144,651

(22) Filed: Jun. 6, 2005

(30) Foreign Application Priority Data
Dec. 30, 2004 (CN) 200410081846.9

(51) Int. Cl. H04R 3/00

(52) U.S. Cl. 381/122; 381/111

(57) ABSTRACT

A multi-effect processing device for wireless microphone is disclosed to include a radio frequency-to-audio frequency converter module for receiving a radio frequency signal and processing the signal into an audio frequency signal, a DSP (Digital Signal Processor) for processing the audio frequency signal from the radio frequency-to-audio frequency converter module through the processes including at least one function selected from the group consisting of Echo, Reverb, Equalization, Compressor, Limiter, Expander, Feedback controller, and Noise Gate, and an output circuit electrically connected to the DSP for output the processed audio frequency signal from the DSP to external audio output apparatus.

### BACKGROUND OF THE INVENTION

1. Field of the Invention

The present invention relates generally to the processing of audio signal and more particularly, to a multi-effect processing device for wireless microphone.

2. Description of the Related Art

A wireless microphone has a sound-effect processing device for processing input signal. However, this sound-effect processing device has only a simple processing function. In order to provide multiple sound effects, external sound-effect processing apparatus may be used. However, it is expensive and requires much installation space when multiple sound-effect processing apparatus are used with a wireless microphone. Further, signal distortion may occur when multiple external sound-effect processing apparatus are used with a wireless microphone.

### SUMMARY OF THE INVENTION

The present invention has been accomplished under the circumstances in view. It is one object of the present invention to provide a multi-effect processing device for wireless microphone, which is an integrated device capable of processing different sound effects. It is another object of the present invention to provide a multi-effect processing device for wireless microphone, which uses less number of parts and has a simplified circuit design and compact size.

To achieve these and other objects of the present invention, the multi-effect processing device for wireless microphone comprises a radio frequency-to-audio frequency converter module for receiving a radio frequency signal and processing the signal into an audio frequency signal, a DSP (Digital Signal Processor) for processing the audio frequency signal from the radio frequency-to-audio frequency converter module through the processes including at least one function selected from the group consisting of Echo, Reverb, Equalization, Compressor, Limiter, Expander, Feedback controller, and Noise Gate, and an output circuit electrically connected to the DSP for output the processed audio frequency signal from the DSP to external audio output apparatus.

### BRIEF DESCRIPTION OF THE DRAWINGS

FIG. 1 is a system block diagram of the present invention (I).

FIG. 2 is a system block diagram of the present invention (II).

### DETAILED DESCRIPTION OF THE INVENTION

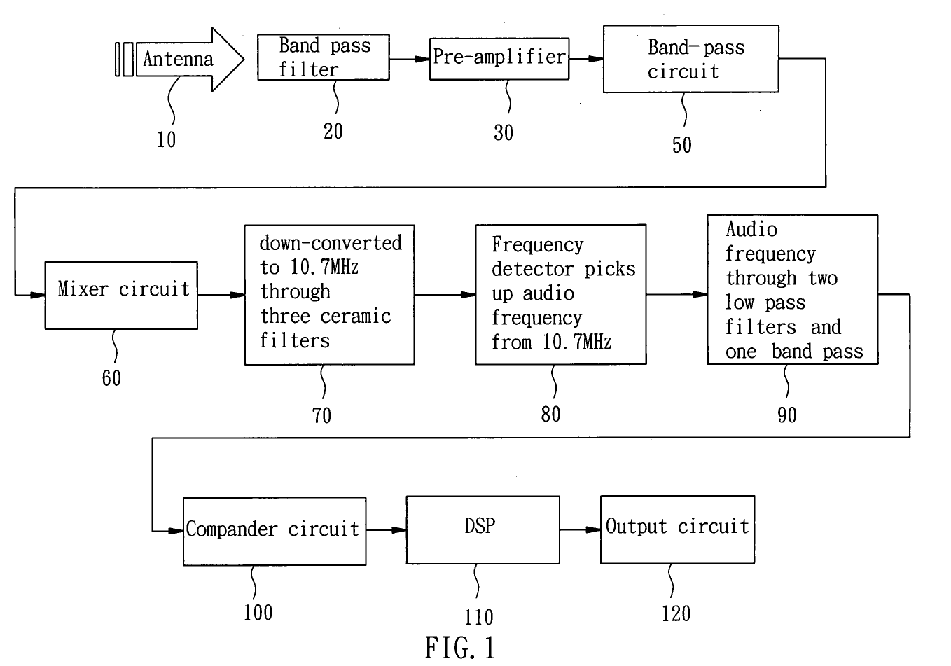

Referring to FIG. 1, a multi-effect processing device for wireless microphone in accordance with the present invention is shown comprising:

an antenna 10 for receiving wireless signal;

a band pass filter 20 electrically connected to the antenna 10;

a pre-amplifier 30 electrically connected to the band pass filter 20;

a band-pass circuit 50 electrically connected to the pre-amplifier 30;

a mixer circuit 60 electrically connected to the band-pass circuit 50;

a down-converter 70 electrically connected to the mixer circuit 60;

an intermediate frequency processor 80 electrically connected to the down-converter 70;

a low frequency processor 90 electrically connected to the intermediate frequency processor 80 and forming with the intermediate frequency processor 80 a frequency processing unit;

an compander circuit 100 electrically connected to the low frequency processor 90; and

a DSP (Digital Signal Processor) 110 electrically connected to the compander circuit 100; and

an output circuit 120 electrically connected to the DSP 110 for outputting audio frequency signal to external audio output devices.

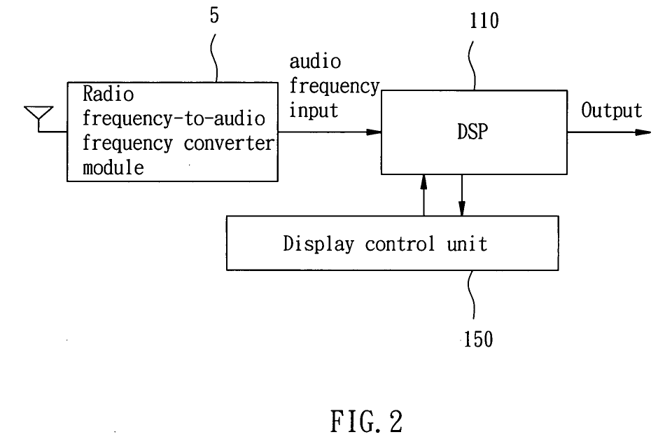

The band pass filter 20 forms with the pre-amplifier 30 a pre-processing unit. The band-pass circuit 50 forms with the mixer circuit 60, the down-converter 70, the intermediate frequency processor 80, the low frequency processor 90 and the compander circuit 100 a post-processing unit, which forms with the pre-processing unit a radio frequency-to-audio frequency converter module 5 (see also FIG. 2).

The DSP 110 is made in the form of an IC (Integrated Circuit) chip electrically connected to the compander circuit 100 of the radio frequency-to-audio frequency converter module 5, and adapted to simultaneously process multiple sound effects including at least one function selected from the group consisting of:

(1) Echo: to repeatedly overlay sound waves of a singing;

(2) Reverb: to continue in a series of echoes;

(3) Equalization: to make different frequencies equal in strength;

(4) Compressor: to compress different audio frequency levels;

(5) Limiter: to limit the strength of different audio frequency levels;

(6) Expander: to adjust amplification scale of the strength of different audio frequency levels;

(7) Feedback controller: to constrains feedback noises; and

(8) Noise Gate: to constrain noise level.

The multi-effect processing device further comprises a display control unit 150 having a set of control switches and a display panel for adjusting and visually checking different sound-effect processing status of the DSP 110, as shown in FIG. 2.

Referring to FIG. 1 again, after having received processed signal from the radio frequency-to-audio frequency converter module 5 by the DSP 110, different controls can be executed through the display control unit 150, and the processed result is shown on the display panel of the display control unit 150, then output audio signal via the output circuit 120 and achieve above said multiple sound effects.

As indicated above, the invention has the following features:

1. The multi-effect processing device for wireless microphone of the present invention is an integrated device capable of processing different sound effects.

2. The multi-effect processing device for wireless microphone of the present invention uses less number of parts and has a simplified circuit design and compact size.

What is claimed is:

1. A multi-effect processing device for wireless microphone comprising:
a radio frequency-to-audio frequency converter module adapted to receive a radio frequency signal and to process the signal into an audio frequency signal;
a DSP (Digital Signal Processor) formed of an integrated circuit and electrically connected to said radio frequency-to-audio frequency converter module and adapted to process the audio frequency signal from said radio frequency-to-audio frequency converter module through the processes including at least one function selected from the group consisting of:
(1) Echo: to repeatedly overlay sound waves of a singing;
(2) Reverb: to continue in a series of echoes;
(3) Equalization: to make different frequencies equal in strength;
(4) Compressor: to compress different audio frequency levels;
(5) Limiter: to limit the strength of different audio frequency levels;
(6) Expander: to adjust amplification scale of the strength of different audio frequency levels;
(7) Feedback controller: to constrains feedback noises; and
(8) Noise Gate: to constrain noise level; and
an output circuit electrically connected to said DSP for output the processed audio frequency signal from said DSP to external audio output means.

2. The multi-effect processing device for wireless microphone as claimed in claim 1, further comprising a display control unit, said display control unit comprising a set of control switches and a display panel for adjusting and visually checking different sound-effect processing status of said DSP.

3. The multi-effect processing device for wireless microphone as claimed in claim 1, wherein said radio frequency-to-audio frequency converter module comprises an compander circuit.

4. The multi-effect processing device for wireless microphone as claimed in claim 3, wherein said DSP is electrically connected to said compander circuit of said radio frequency-to-audio frequency converter module.
